(19) United States
(12) Patent Application Publication
(10) Pub. No.: US 2018/0166751 A1
(43) Pub. Date: Jun. 14, 2018

(54) METHODS AND SYSTEMS FOR MONITORING REMAINING USEFUL SHELF LIFE OF A BATTERY

(71) Applicant: Morpho Detection, LLC, Newark, CA (US)

(72) Inventor: VICTOR KIRK BOISSERÉE, Fremont, CA (US)

(21) Appl. No.: 15/374,378

(22) Filed: Dec. 9, 2016

(51) Int. Cl. H01M 10/48; H01M 10/42

(52) U.S. Cl. CPC H01M 10/488; H01M 10/4257; H01M 10/486

(57) ABSTRACT

A battery shelf life indicator (BSLI) module, systems, and methods for monitoring remaining useful shelf life of a battery are provided herein. The BSLI module includes a temperature sensor configured to measure an ambient temperature proximate to the battery, and a processor configured to determine the remaining useful shelf life of the battery based on the measured ambient temperature. The BSLI module also includes a communication device configured to transmit battery-state data corresponding to the determined remaining useful shelf life to a server computing device.

### BACKGROUND OF THE INVENTION

The embodiments described herein relate generally to battery shelf life, and more particularly to systems and methods for monitoring remaining useful shelf life of a battery.

At least some known batteries have limited shelf lives. A shelf life is a time required for the voltage of an unused battery to drop below a predetermined percentage of its original voltage. In some applications, for example, in Uninterruptible Power Supplies (UPS), one or more batteries or backup batteries may be stored in a warehouse or machine operating environment for extended periods of time without being used or recharged. The shelf lives of such batteries may be influenced by factors such as battery discharge rate, ambient temperature, and battery age. Due to these factors, it may be difficult to determine and monitor the shelf lives of these batteries.

Some known batteries include “fuel gages” that indicate a current charge level on the battery. However, the fuel gage on each battery must be manually activated by a technician to determine the charge level of the battery, which is then manually recorded by the technician. Some other known battery monitoring systems enable tracking and storage of battery data. The technician must then use portable data storage media, such as a portable flash drive, to retrieve battery data load it onto a mobile computing device. The technician then transmits the battery data from the mobile computing device to a remote server system operated by a manufacturer or technical support team for further analysis. As a result, known battery useful shelf life monitoring systems may be time-consuming, complicated, and laborious. Such monitoring systems become even more complicated when one or more pallets each having a plurality of batteries are stored in the warehouse or machine operating environment.

### BRIEF DESCRIPTION OF THE INVENTION

In one aspect, a battery shelf life indicator (BSLI) module for monitoring remaining useful shelf life of a battery is provided herein. The BSLI module includes a temperature sensor configured to measure an ambient temperature proximate to the battery, and a processor configured to determine the remaining useful shelf life of the battery based on the measured ambient temperature. The BSLI module also includes a communication device configured to transmit battery-state data corresponding to the determined remaining useful shelf life to a server computing device.

In another aspect, a method of monitoring remaining useful shelf life of a battery using a BSLI module is provided. The BSLI module is in communication with a server computing device. The method includes measuring, by a temperature sensor of the BSLI module, an ambient temperature proximate to the battery, determining, by a processor of the BSLI module, the remaining useful shelf life of the battery based on the ambient temperature measured by the temperature sensor, and transmitting, by a communication device of the BSLI module, battery-state data corresponding to the determined remaining useful shelf life to a server computing device.

In another aspect, a system for monitoring remaining useful shelf life of a battery in an environment is provided. The system includes a BSLI module configured to calculate the remaining useful shelf life of the battery. The BSLI module includes a temperature sensor configured to measure an ambient temperature proximate to the battery, a processor configured to determine the remaining useful shelf life of the battery based on the measured ambient temperature from the temperature sensor, and a communication device configured to transmit battery-state data corresponding to the determined remaining useful shelf life to a server computing device. The system also includes a server computing device in communication with the BSLI module and configured to receive the battery-state data from said BSLI module, determine whether the battery-state data includes an alarm condition, store the battery-state data in a memory device, and display an alert message on a display device of said server computing device, the alert message detailing a fault mode for the battery.

### BRIEF DESCRIPTION OF THE DRAWINGS

FIG. 1 is a block diagram of an environment that includes at least one battery, a BSLI module, a mobile computing device, and a server computing device.

FIG. 2 is a block diagram of an example BSLI module used in the environment shown in FIG. 1.

FIG. 3 is a flow chart of an example process performed by the BSLI module shown in FIG. 1 for monitoring a remaining useful shelf life of one or more batteries.

### DETAILED DESCRIPTION OF THE INVENTION

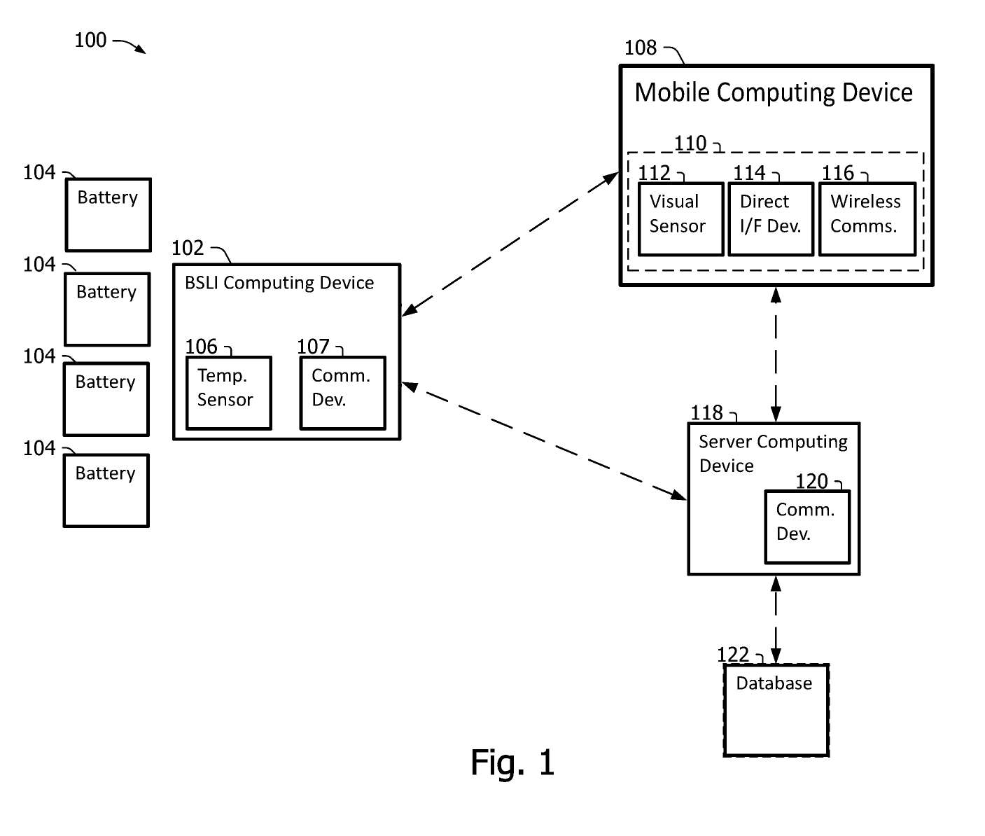

FIG. 1 is a block diagram of an environment 100 that includes a battery shelf life indicator (BSLI) module 102 for monitoring a shelf life of one or more batteries 104 being stored in environment 100. For example, in some implementations, environment 100 is a warehouse or machine operating environment where a plurality of batteries 104 are used and/or stored. Alternatively, environment 100 may be any type of environment where at least one battery is used and/or stored.

In an exemplary implementation, battery 104 is a battery used in an uninterruptible power supply (UPS). However, battery 104 may be any type of battery for use in any environment than enables BSLI module 102 to function as described herein.

BSLI module 102 is packaged in environmentally-protected packaging such that sealing of the packaging satisfies IP44 requirements and meets applicable UL, CUL, and CE EMI emission requirements. In one implementation, a single BSLI module 102 may be positioned near batteries 104 for monitoring a shelf life of batteries 104, either individually or collectively as a group. In another implementation, BSLI module 102 may be provided within the packaging of a particular battery 104 and configured to monitor a shelf life of batteries 104. Alternatively, each battery 104 may include a respective BSLI module 102 that monitors shelf life of each respective battery 104. BSLI module 102 is configured to track time stored on the shelf for battery 104 and based on periodic temperature measurements of environment 100, calculate a remaining useful shelf life of battery 104, as described in more detail herein. BSLI module 102 includes or is coupled to a temperature sensor 106 for receiving the temperature measurements.

BSLI module 102 also includes a communication device 107 for communicating with external devices in environment 100. Communication device 107 is communicatively couplable to a remote device such as a mobile computing device 108 and/or a server computing device 118. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), an 802.11 wireless network (WLAN), or a Bluetooth connection.

Environment 100 additionally includes mobile computing device 108 that is communicatively coupled to BSLI module 102. Mobile computing device 108 includes a communication device 110 for communicating with BSLI module 102. Communication device 110 may include, for example, a visual sensor 112, such as a camera or barcode scanner, a direct interface device 114, such as a USB connection, and/or a wireless communication device 116. To program BSLI module 102 to monitor a battery or batteries 104, a user uses communication device 110 to transmit or push battery identification information to BSLI module 102. Battery data may include at least a serial number that indicates a type, a capacity, or any other battery data that enables system 100 to function as described herein. In one implementation, the user may request battery condition data, including a remaining useful shelf life of battery 104, from BSLI module 102.

Additionally, environment 100 includes server computing device 118 that is communicatively coupled to BSLI module 102 and mobile computing device 108. Server computing device 118 includes a communication device 120, for example, a wired or wireless communication device, for communicating with BSLI module 102 and/or mobile computing device 108. Server computing device 112 is also in communication with a database 122.

Real-time application software is preferably used by the devices in environment 100 to communicate across a network. BSLI software enables BSLI module 102 to input, output, print, and/or communicate shelf life data, alerts, and/or history. Server software monitors and receives data from BSLI module 102 on the network, provides updates, and manages the service life v. temperature curves.

During operation, BSLI module 102 monitors ambient temperature proximate battery 104 and continuously calculates a remaining shelf life for battery 104. When the calculated remaining shelf life of battery 104 falls below a predetermined level, BSLI module 102 generates and transmits an alert signal to mobile computing device 108 and/or server computing device 112. The alert signal is displayed to a system manager, who may then take the appropriate steps to recharge or replace battery 104. Once recharged or replaced, the system manager uses server computing device 112 to command BSLI module 102 to restart the shelf life calculation for battery 104 from a fully-charged state.

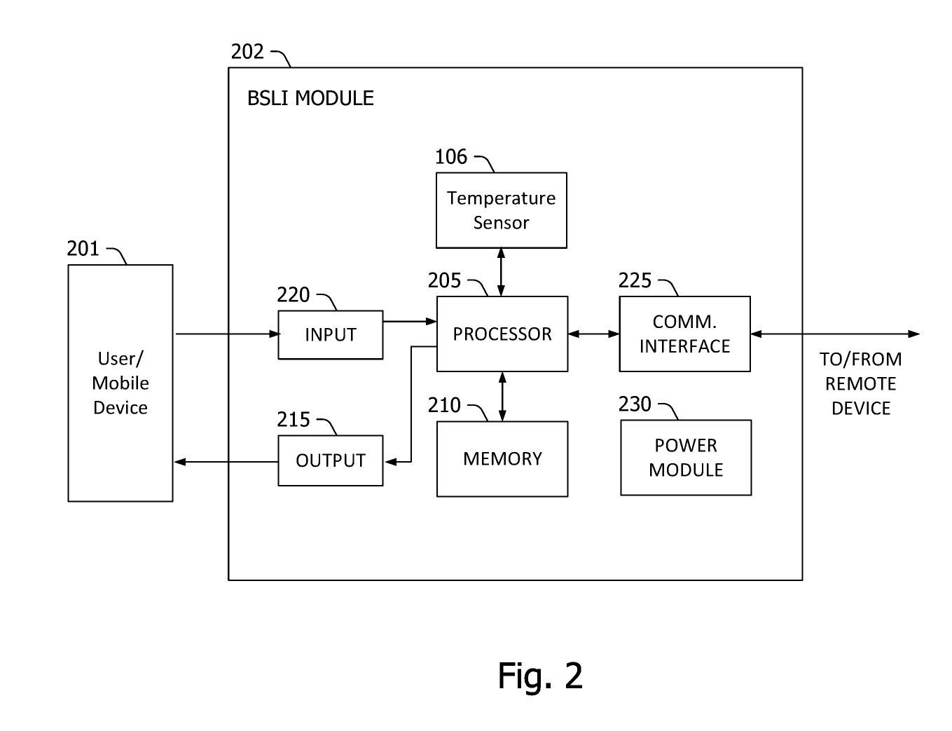

FIG. 2 illustrates an example configuration of a client computing device 202 that operates automatically or is operated by a user 201. Client computing device 202 is representative of BSLI module 102 and mobile computing device 108. Client computing device 202 includes one or more processors 205 for executing instructions. In some embodiments, executable instructions are stored in one or more memory devices 210. Processor 205 may include one or more processing units (e.g., in a multi-core configuration). Memory device 210 is any one or more devices allowing information such as executable instructions and/or other data to be stored and retrieved. Memory device 210 may include one or more computer-readable media. Stored on memory device 210 are various types of data, including the battery serial number, date-in service information, and battery-specific performance data, for example, battery voltage versus discharge curves and/or battery useful life versus temperature curves. Other data stored on memory device 210 may include instructions or algorithms that enable processor 205 to calculate the battery shelf life based on ambient temperature, time in-service, and/or present voltage. Alarm data is further stored on memory device 210, which defines alarm states for when BSLI computing device should send and alert signal to server computing device 118. Alarm states include, for example, the predicted useful life is less than an expected/required life of battery 104, battery 104 requires recharging, and/or battery 104 has discharged and is not rechargeable.

Client computing device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device or an audio output device (e.g., a speaker or headphones). The display device may be, for example, a liquid crystal display (LCD), organic light emitting diode (OLED) display, cathode ray tube (CRT), or “electronic ink” display.

In some embodiments, client computing device 202 includes an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, an audio input device, a camera or other visual sensor, a barcode scanner, a magnetic sensor, and/or an radio frequency sensor. A single component such as a touch screen may function as both an output device of media output component 215 and input device 220.

Client computing device 202 may also include a communication interface 225, which is communicatively couplable to remote devices such as server computing device 118 and/or mobile computing device 108. Communication interface 225 may include, for example, a wired or wireless network adapter or a wireless data transceiver for use with a mobile phone network (e.g., Global System for Mobile communications (GSM), 3G, 4G or Bluetooth), an 802.11 wireless network (WLAN), or other mobile data network (e.g., Worldwide Interoperability for Microwave Access (WIMAX)).

Stored in one or more memory devices 210 are, for example, computer-readable instructions for monitoring a battery shelf life of battery 104 based on ambient temperature, providing battery condition data to mobile computing device 108 to user 201 via media output component 215 and, optionally, receiving and processing battery data received from mobile computing device 108 via input device 220.

Client computing device 202 also includes a power module 230 for powering BSLI module 102. In one implementation, power module 230 includes a rechargeable battery and a power connection port for connection to an external power source for recharging BSLI module 102. In another implementation, power module 230 includes a non-rechargeable battery, for example, a lithium-ion battery. The non-rechargeable battery is selected such that it is capable of powering BSLI module 102 continuously for at least 3 years.

Client computing device 202 further includes temperature sensor 106 (shown in FIG. 1) for monitoring ambient temperature proximate battery 104. Temperature sensor 106 may include any type of sensor capable of measuring temperature as known in the art. Temperature sensor 106 continuously measures ambient temperature and transmits an ambient temperature signal to processor 205 for use in determining the remaining shelf life of battery 104.

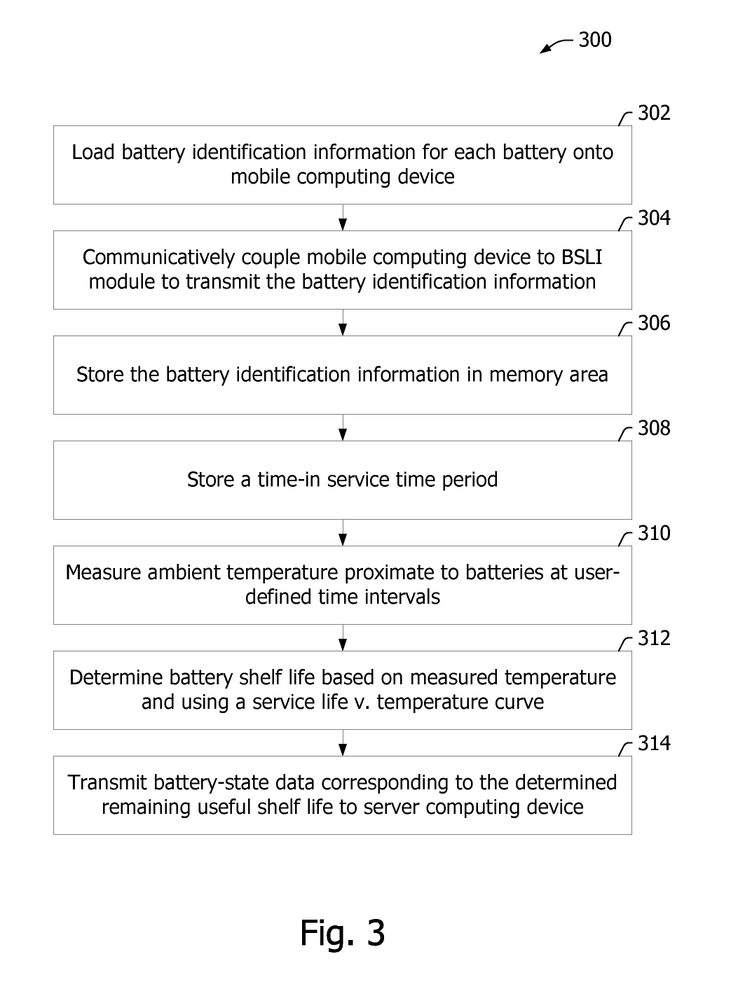

FIG. 3 is a flow chart of an example process 300 performed by BSLI module 102 for monitoring a remaining useful shelf life of one or more batteries (e.g., battery 104). The steps of the monitoring process flow are numbered for descriptive purposes and should not be taken to be limiting on the order in which the steps must be completed. In other words, some steps of either process may be performed in an alternative order and/or certain steps may be performed substantially simultaneously.

To begin the process flow and to program BSLI module 102 to monitor one or more new batteries 104, a technician or user loads 302 battery identification information for each battery 104 on mobile computing device 108. Battery identification information may include, for example, a battery serial number, battery-specific performance data, and/or time-in service information.

The technician communicatively couples 304 mobile computing device 108 to BSLI module 102 to transmit the battery identification information to BSLI module 102. The connectivity may be wired or wireless, as described above. Upon receipt by BSLI module 102, processor 205 stores 306 the battery identification information in memory area 210. In the exemplary implementation, memory area 210 of BSLI module 102 is provided with battery-specific performance data for a plurality of different types of batteries 104. The battery-specific performance data may be provided by the battery manufacturer or may be end-user derived storage temperature versus shelf life performance data. Processor 205 stores 308 a time-in service, representing a time that battery 104 has been unplugged or unused.

When monitoring has started, temperature sensor 106, 235 measures 310 ambient temperature proximate to batteries 104 at user-defined intervals. For example, temperature sensor 106 periodically measures one or more average or estimated temperatures over a time period since a previous measurement. This interval may be set for multiple times per second or may be set up to a few times per hour. Other sample rates are possible and configurable depending on desired precision.

Based on the ambient temperature measurements, processor 205 determines 312 a shelf life, e.g., from a temperature versus service life curve provided by the battery manufacturer or derived by the end-user. The discharge rate is applied to the time and temperature over which it was determined to apply, and in conjunction with previous measurements, a determination is made as to remaining useful shelf life of battery 104.

When processor 205 receives or determines an error condition, the battery-powered BSLI module 102 transmits 314 battery-state data corresponding to the determined remaining useful shelf life to server computing device 118. The battery-state data indicates that there is a problem for a specific battery 104 having a serial number xxxx. In one embodiment, BSLI module 102 is configured to generate the alert warning when battery falls below a specified threshold charge level. BSLI module 102 reports that the threshold level has been reached and that battery needs to be replaced, serviced, charged, etc.

It should be understood that processor as used herein means one or more processing units (e.g., in a multi-core configuration). The term processing unit, as used herein, refers to microprocessors, microcontrollers, reduced instruction set circuits (RISC), application specific integrated circuits (ASIC), logic circuits, and any other circuit or device capable of executing instructions to perform functions described herein.

It should be understood that references to memory mean one or more devices operable to enable information such as processor-executable instructions and/or other data to be stored and/or retrieved. Memory may include one or more computer readable media, such as, without limitation, hard disk storage, optical drive/disk storage, removable disk storage, flash memory, non-volatile memory, ROM, EEPROM, random access memory (RAM), and the like.

Additionally, it should be understood that communicatively coupled components may be in communication through being integrated on the same printed circuit board (PCB), in communication through a bus, through shared memory, through a wired or wireless data communication network, and/or other means of data communication. Additionally, it should be understood that data communication networks referred to herein may be implemented using Transport Control Protocol/Internet Protocol (TCP/IP), User Datagram Protocol (UDP), or the like, and the underlying connections may comprise wired connections and corresponding protocols, for example, Institute of Electrical and Electronics Engineers (IEEE) 802.3 and/or wireless connections and associated protocols, for example, an IEEE 802.11 protocol, an IEEE 802.15 protocol, and/or an IEEE 802.16 protocol.

A technical effect of systems and methods described herein includes at least one of: (a) measuring an ambient temperature proximate to the battery using a temperature sensor of the BSLI module; (b) determining, by a processor of the BSLI module, the remaining useful shelf life of the battery based on the measured ambient temperature; and (c) transmitting, by a communication device of the BSLI module, battery-state data corresponding to the determined remaining useful shelf life to a server computing device.

As compared to known systems for monitoring remaining useful shelf life of a battery or a plurality of batteries stored in the same environment, the systems and methods described herein enable a BSLI module to continuously assess and monitor a battery's shelf life, and automatically transmit an alert to a central server computing device when a charge level of the battery falls below a pre-defined threshold, without requiring a technician to physically access the monitoring computing device to transfer physical storage media between the monitoring computing device and the server computing device.

Exemplary embodiments of systems and methods for monitoring remaining useful shelf life of a battery are described above in detail. The methods and systems are not limited to the specific embodiments described herein, but rather, components of systems and/or steps of the methods may be utilized independently and separately from other components and/or steps described herein. For example, the methods may also be used in combination with other systems and methods, and are not limited to practice with only the systems as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A battery shelf life indicator (BSLI) module for monitoring remaining useful shelf life of a battery, said BSLI module comprising:
a temperature sensor configured to measure an ambient temperature proximate to the battery;
a processor configured to determine the remaining useful shelf life of the battery based on the measured ambient temperature from said temperature sensor; and
a communication device configured to transmit battery-state data corresponding to the determined remaining useful shelf life to a server computing device.

2. The BSLI module of claim 1, wherein said temperature sensor is configured to continuously measure the ambient temperature at pre-defined time intervals.

3. The BSLI module of claim 1, wherein to determine the remaining useful shelf life, said processor is further configured to:
retrieve a service-life versus temperature curve from a memory device; and
apply a discharge rate to the time and temperature over which the discharge rate was determined to apply on the service-life versus temperature curve.

4. The BSLI module of claim 1, wherein said communication device is configured to transmit the battery-state data upon at least one of completion of a pre-defined interval, receipt of a battery-state data request from an external device, and occurrence of an alarm condition.

5. The BSLI module of claim 4, wherein the alarm condition occurs when one of the determined remaining useful shelf life is less than an expected remaining useful shelf life, the battery needs recharging, and the battery is discharged, and the battery is not rechargeable.

6. The BSLI module of claim 1, wherein said processor is further configured to:
receive battery identification information, including at least one of battery-specific performance data, a battery serial number, and time-in service information; and
store the battery identification information in a memory device coupled to said processor.

7. The BSLI module of claim 1, wherein said BSLI module is positioned within a packaging of the battery during manufacture.

8. The BSLI module of claim 7, further configured to individually monitor remaining useful shelf lives of a plurality of additional batteries proximate to the battery.

9. The BSLI computing device of claim 1, wherein said communication device is configured for wired or wireless communication.

10. A method of monitoring remaining useful shelf life of a battery using a BSLI module in communication with a server computing device, said method comprising:
measuring, by a temperature sensor of the BSLI module, an ambient temperature proximate to the battery;
determining, by a processor of the BSLI module, the remaining useful shelf life of the battery based on the ambient temperature measured by the temperature sensor; and
transmitting, by a communication device of the BSLI module, battery-state data corresponding to the determined remaining useful shelf life to a server computing device.

11. The method of claim 10, wherein measuring the ambient temperature further comprises continuously measuring the ambient temperature at pre-defined time intervals.

12. The method of claim 10, wherein determining the remaining useful shelf life further comprises:
retrieving a service-life versus temperature curve from a memory device; and
applying a discharge rate to the time and temperature over which the discharge rate was determined to apply on the service-life versus temperature curve.

13. The method of claim 10, further comprising transmitting the battery-state data upon at least one of completion of a pre-defined interval, receipt of a battery-state data request from an external device, or occurrence of an alarm condition.

14. The method of claim 13, further comprising transmitting the alarm condition upon occurrence of one of the determined remaining useful shelf life is less than an expected remaining useful shelf life, the battery needs recharging, the battery is discharged, or the battery is not rechargeable.

15. The method of claim 10, further comprising:
receiving battery identification information, including at least one of battery-specific performance data, a battery serial number, and time-in service information; and
storing the battery identification information in a memory device coupled to the processor.

16. The method of claim 10, further comprising one of positioning the BSLI module within a packaging of the battery during manufacture, packaging the BSLI module within a shipping container for the battery, or packaging the BSLI module within a shipping container for a plurality of batteries.

17. A system for monitoring remaining useful shelf life of a battery in an environment, said system comprising:
a BSLI module configured to calculate the remaining useful shelf life of the battery, said BSLI module comprising:
a temperature sensor configured to measure an ambient temperature proximate to the battery;
a processor configured to determine the remaining useful shelf life of the battery based on the measured ambient temperature from said temperature sensor; and
a communication device configured to transmit battery-state data corresponding to the determined remaining useful shelf life to a server computing device; and
a server computing device in communication with said BSLI module, said server computing device configured to:
receive the battery-state data from said BSLI module;
determine whether the battery-state data includes an alarm condition;
store the battery-state data in a memory device; and
display an alert message on a display device of said server computing device, the alert message detailing the alarm condition for the battery.

18. The system of claim 17, wherein the alarm condition for the battery occurs when one of the determined remaining useful shelf life is less than an expected remaining useful shelf life, the battery needs recharging, the battery is discharged, or the battery is not rechargeable.

19. The system of claim 17, further comprising a mobile computing device configured to:
receive battery identification information input by a user into said mobile computing device, the battery identification information including at least one of battery-specific performance data, a battery serial number, or time-in service information;
establish a communication connection with said BSLI module using a communication device; and
transmit the battery identification information to said BSLI module using the communication device.

20. The system of claim 19, wherein said mobile computing device is further configured to:
request battery condition data from said BSLI module based on input received from the user, the battery condition data including at least one of a remaining useful shelf life of battery, a shelf life history for the battery since monitored by said BSLI module, and an alarm condition history for the battery; and
display the received battery condition data on a display screen of said mobile computing device.
